(19) United States
(12) Patent Application Publication
(10) Pub. No.: US 2015/0091954 A1
(43) Pub. Date: Apr. 2, 2015

(54) LIQUID CRYSTAL DISPLAY DEVICE

(71) Applicant: Japan Display Inc., Tokyo (JP)

(72) Inventors: Takahiro OCHIAI, Tokyo (JP); Yoshinori AOKI, Tokyo (JP); Hideo SATO, Tokyo (JP); Yoshihiro KOTANI, Tokyo (JP); Youichi OOKI, Tokyo (JP)

(73) Assignee: Japan Display Inc.,, Tokyo (JP)

(21) Appl. No.: 14/501,099

(22) Filed: Sep. 30, 2014

(30) Foreign Application Priority Data
Oct. 1, 2013 (JP) 2013-206798

(51) Int. Cl. G09G 3/36

(52) U.S. Cl. CPC G09G 3/3648; G09G 3/3607; G09G 2330/021
USPC 345/690; 345/89

(57) ABSTRACT

A liquid crystal display device includes: pixel electrodes to each of which a potential corresponding to a gray-scale value is applied, for a plurality of pixels arranged in a matrix in a display area, via a pixel transistor of each of the pixels; a common electrode forming, in cooperation with the pixel electrode, an electric field to align a liquid crystal composition; a plurality of scanning signal lines each connected in common to gates of the pixel transistors of the plurality of pixels constituting each of a plurality of rows forming the matrix; and a driver circuit setting, after powering on and before displaying an image in the display area, the common electrode into a high impedance state and then setting the scanning signal line to an inactive potential to cut off a source and a drain of the pixel transistor from each other.

### CROSS-REFERENCE TO RELATED APPLICATION

The present application claims priority from Japanese application JP2013-206798 filed on Oct. 1, 2013, the content of which is hereby incorporated by reference into this application.

### BACKGROUND OF THE INVENTION

1. Field of the Invention

The present invention relates to a liquid crystal display device.

2. Description of the Related Art

As thin display devices used for information communication terminals or television receivers, liquid crystal display devices have been widely used. The liquid crystal display device is a device that displays an image by changing the alignment of a liquid crystal composition sealed between two substrates with a change in electric field formed by a potential difference between a pixel electrode and a counter electrode to thereby control the degree of transmission of light coming from a backlight and passing through the two substrates and the liquid crystal composition.

In such a liquid crystal display device, pixel transistors each for applying a voltage to the pixel electrode in each pixel are arranged. In general, the gates of pixel transistors corresponding to one line of a screen are connected to one signal line (hereinafter referred to as “scanning signal line”), and the scanning signal lines are controlled by a driver circuit so as to sequentially output an active voltage to render the pixel transistors conductive for each line.

JP 2009-201243 A discloses that control to first raise a voltage of a counter electrode is performed to prevent a transient DC component from being applied to a pixel electrode at the time of powering on a liquid crystal display device. JP H07-261716 A discloses that a voltage to be applied to a boost circuit of a display device is lowered on startup.

In the liquid crystal display device, the backlight is turned on after powering on and before the start of display in some cases for stably turning on the backlight at the start of display. In such a case, the light of the backlight leaks out in some cases from a display screen before the start of display.

The invention has been made in view of the circumstances described above, and it is an object of the invention to provide a liquid crystal display device in which light leakage before the start of display during powering on is suppressed.

A liquid crystal display device according to an aspect of the invention includes: pixel electrodes to each of which a potential corresponding to a gray-scale value is applied, for a plurality of pixels arranged in a matrix in a display area, via a pixel transistor of each of the pixels; a common electrode forming, in cooperation with the pixel electrode, an electric field to align a liquid crystal composition; a plurality of scanning signal lines each connected in common to gates of the pixel transistors of the plurality of pixels constituting each of a plurality of rows forming the matrix; and a driver circuit setting, after powering on and before displaying an image in the display area, the common electrode into a high impedance state and then setting the scanning signal line to an inactive potential to cut off a source and a drain of the pixel transistor from each other.

In the liquid crystal display device according to the aspect of the invention, the driver circuit may perform control such that in a change in the scanning signal line to the inactive potential, the time from the start to the end of the change is 1 ms or more.

In the liquid crystal display device according to the aspect of the invention, the driver circuit may set the scanning signal line to the inactive potential in a stepwise manner.

In the liquid crystal display device according to the aspect of the invention, a portion of the plurality of scanning signal lines may be set to the inactive potential, and then the remaining scanning signal lines maybe set to the inactive potential. In this case, the portion of the scanning signal lines may be any of an odd-numbered scanning signal line and an even-numbered scanning signal line.

A liquid crystal display device according to another aspect of the invention includes: pixel electrodes to each of which a potential corresponding to a gray-scale value is applied, for a plurality of pixels arranged in a matrix in a display area, via a pixel transistor of each of the pixels; a common electrode forming, in cooperation with the pixel electrode, an electric field to align a liquid crystal composition; a plurality of scanning signal lines each connected in common to gates of the pixel transistors of the plurality of pixels constituting each of a plurality of rows forming the matrix; and a driver circuit setting, after powering on and before displaying an image in the display area, the scanning signal line to an inactive potential to cut off a source and a drain of the pixel transistor from each other, wherein the driver circuit performs control such that the time from the start to the end of a change in the scanning signal line to the inactive potential is 1 ms or more.

### BRIEF DESCRIPTION OF THE DRAWINGS

FIG. 1 is a diagram schematically showing a liquid crystal display device according to an embodiment of the invention.

FIG. 2 is a diagram showing the configuration of a liquid crystal panel of FIG. 1.

FIG. 3 is a diagram showing an equivalent circuit in each pixel.

FIG. 4 is a diagram showing one circuit block of a driver circuit, the circuit block outputting a signal to a scanning signal line.

FIG. 5 is a timing diagram showing changes in main signals of a circuit from power-on of the liquid crystal display device to the start of display.

FIG. 6 is a graph schematically showing changes in a gate potential, a pixel potential, and a common potential during power-on in a related-art example.

FIG. 7 is a graph schematically showing changes in the gate potential, the pixel potential, and the common potential during power-on according to the liquid crystal display device of the embodiment.

FIG. 8 is a graph schematically showing changes in the gate potential, the pixel potential, and the common potential during power-on according to a liquid crystal display device of a modified example of the embodiment.

FIG. 9 is a graph schematically showing changes in the gate potential, the pixel potential, and the common potential during power-on according to the liquid crystal display device of the modified example of the embodiment.

### DETAILED DESCRIPTION OF THE INVENTION

Hereinafter, an embodiment of the invention will be described with reference to the drawings. In the drawings, the same or equivalent elements are denoted by the same reference numerals and signs, and a redundant description is omitted.

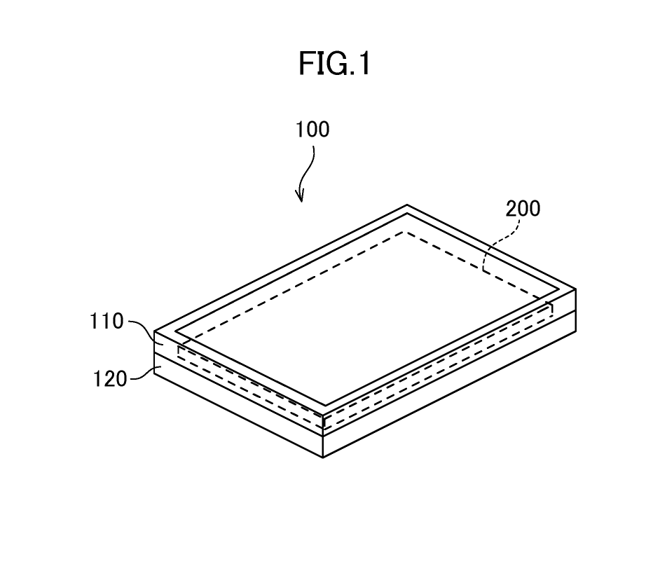

FIG. 1 schematically shows a liquid crystal display device 100 according to the embodiment of the invention. As shown in the drawing, the liquid crystal display device 100 is composed of a liquid crystal panel 200 that is fixed so as to be interposed between an upper frame 110 and a lower frame 120, a backlight device (not shown), and the like.

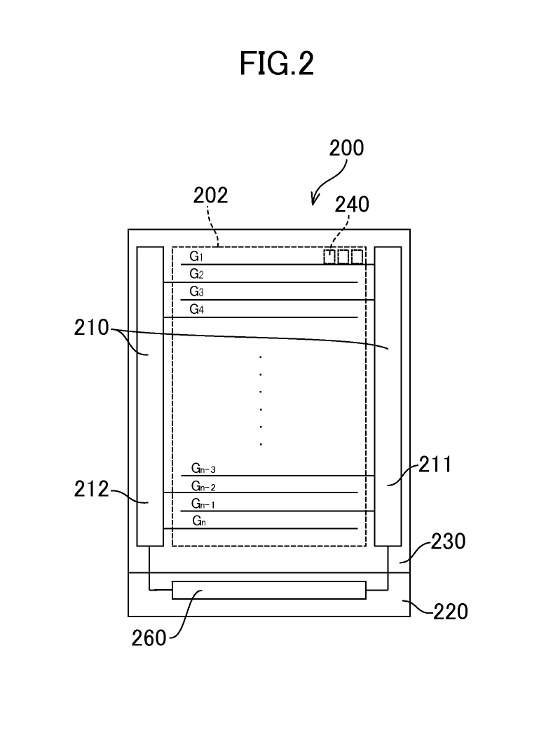

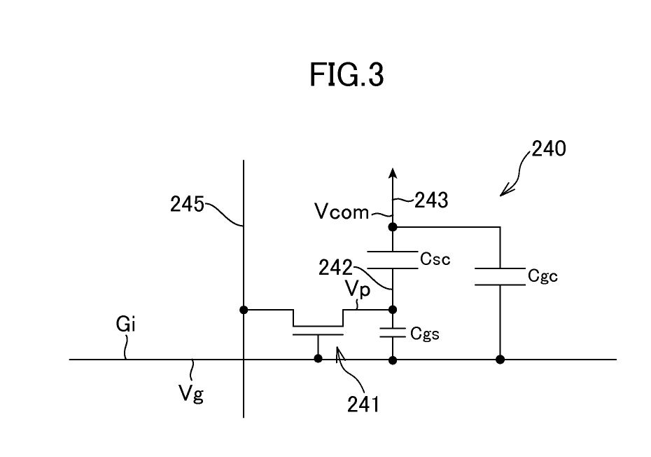

FIG. 2 shows the configuration of the liquid crystal panel 200 of FIG. 1. The liquid crystal panel 200 includes two substrates, a TFT (Thin Film Transistor) substrate 220 and a color filter substrate 230. A liquid crystal composition is sealed between the substrates. The TFT substrate 220 includes a driver circuit 210 that applies sequentially, to scanning signal lines G1 to Gn in selected one of forward and reverse directions, a High potential (active potential) for providing electrical conduction between the source and drain of a TFT arranged in each of pixels 240. Moreover, the TFT substrate 220 includes a driver IC (Integrated Circuit) 260 that controls the driver circuit 210 and applies a voltage corresponding to the gray-scale value of the pixel 240 to a plurality of video signal lines 245 (refer to FIG. 3) extending so as to perpendicularly intersect the scanning signal lines G1 to Gn in a display area 202. The driver circuit 210 includes a right driver circuit 211 located to the right of the display area 202 when facing the drawing and a left driver circuit 212 located to the left of the display area 202.

FIG. 3 is a diagram representing an equivalent circuit of the pixel 240. Each of the pixels 240 includes a pixel electrode 242 to which a pixel potential Vp corresponding to a gray-scale value is applied, a pixel transistor 241 for applying the pixel potential Vp to the pixel electrode 242, the video signal line 245 that is connected to the drain of the pixel transistor 241, and a common electrode 243 that is formed on the entire surface of the display area 202 and forms, in cooperation with the pixel electrode 242, an electric field for controlling the alignment of a liquid crystal composition (not shown). Here, the potential of the common electrode 243 is a common potential Vcom, and the potential of the scanning signal line Gi (i is from 1 to n) is a gate potential Vg. Moreover, a capacitance formed between the scanning signal line Gi and the pixel electrode 242 is a capacitance Cgs, a capacitance formed between the scanning signal line Gi and the common electrode 243 is a capacitance Cgc, and a capacitance formed between the pixel electrode 242 and the common electrode 243 is a capacitance Csc. Here, the luminance of each of the pixels 240 is controlled by changing the pixel potential Vp as a potential corresponding to a gray-scale value to thereby change an electric field between the pixel electrode 242 and the common electrode 243, changing the alignment of the liquid crystal composition (not shown), and changing the polarization of light transmitting through the liquid crystal composition. Formula (1) shows a potential change ΔVp in the pixel electrode 242 when the potential of the scanning signal line Gi is changed by ΔVg.

$$Δ Vp = \frac{Cgs}{( Csc + Cgs )} \times Δ Vg \qquad [ Formula ( 1 ) ]$$

Formula (1) is simplified for illustrative purposes. More specifically, it is necessary to also consider a change in the capacitance Cgs or the like in on and off states of the pixel transistor 241.

With the use of Formula (1), a phenomenon that the light of a backlight leaks before the start of display will be described. It is desirable that a potential equal to that in a display period is set in a period from power-on to the start of display for performing a stable operation after the start of display. That is, it is desirable that the gate potential Vg of the scanning signal line Gi is set to a Low potential (inactive potential). Before the driver IC 260 operates, all of wires of the scanning signal lines Gi, the video signal lines 245, and the common electrode 243 in the display area 202 are at, for example, a GND (ground) potential or the like, and not in a desirable state. Therefore, it is necessary to change the potential before display.

Before the operation of the driver IC 260 after power-on, all of the gate potential Vg, the pixel potential Vp, and the common potential Vcom are the GND potential. Therefore, when the gate potential Vg is shifted to the Low potential before the start of display, the pixel potential Vp is also changed due to the capacitance Cgs as referred to Formula (1). The change in the pixel potential Vp causes a potential difference between the pixel electrode 242 and the common electrode 243. The change in the pixel potential Vp is temporary, so that the pixel potential Vp is changed again to the GND potential that is stable. However, since a potential difference ΔV generated between the pixel electrode 242 and the common electrode 243 temporarily changes the alignment of the liquid crystal composition, the difference is the cause of light leakage in a state where the backlight is turned on.

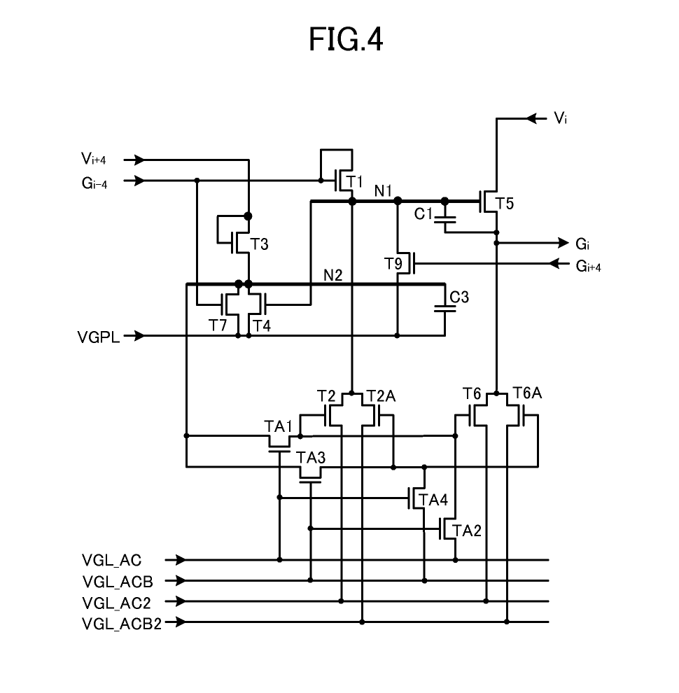

FIG. 4 is a diagram showing one circuit block of the driver circuit 210, the circuit block outputting a signal to the scanning signal line Gi. Here, Vi represents a clock signal, and VGPL and VGPH are signals whose potentials are fixed at the Low potential and the High potential, respectively. Any of these signals is input from the outside.

First, the operation of the driver circuit 210 after the start of display will be briefly described. When the scanning signal line Gi-4 to which a signal is output four horizontal drive periods before the scanning signal line Gi is at the High potential, since the scanning signal line Gi−4 is input to the gate of a transistor T7, the transistor T7 is rendered conductive and a node N2 is connected to VGPL to thereby be at the Low potential. Moreover, since the scanning signal line Gi−4 is also input to a diode-connected transistor T1, a node N1 that is connected to the transistor T1 is at the High potential, so that a potential difference is generated in a capacitance C1 and a transistor T5 is rendered conductive. The node N1 is also connected to the gate of a transistor T4, so that the node N2 is connected with VGPL also through the transistor T4 to thereby be at the Low potential.

Next, when the clock signal Vi is at the High potential, the potential of one of electrodes of the capacitance C1 is at the High potential because the transistor T5 is conductive, so that the gate potential of the transistor T5 on the other electrode side is further boosted due to so-called boot strap. This confirms the High potential of the scanning signal line Gi. When the clock signal Vi is at the Low potential, the scanning signal line Gi is also at the Low potential. For confirming this, the scanning signal line Gi+4 that is at the High potential at the same time is input to the gate of a transistor T9 to render the transistor T9 conductive, so that the node N1 is connected to VGPL to thereby be at the Low potential. On the other hand, a clock signal Vi+4 that is at the High potential at the same time is input to a diode-connected transistor T3, so that the node N2 is at the High potential.

Signals VGL_AC, VGL_ACB, VGL_AC2, and VGL_ACB2 are each an AC signal that is inverted in two vertical synchronization periods. When VGL_AC and VGL_ACB2 are at the High potential while VGL_ACB and VGL_AC2 being at the Low potential in a certain cycle, the signal at the node N2 at the High potential passes through a transistor TA1 that is conductive, and is input to the gates of a transistor T2 and a transistor T6 to thereby render the transistors conductive. The transistor T2 and the transistor T6 connect VGL_AC2 at the Low potential with the node N1 and the scanning signal line Gi, respectively.

When VGL_AC and VGL_ACB2 are at the Low potential while VGL_ACB and VGL_AC2 being at the High potential in another cycle, a transistor T2A and a transistor T6A operate similarly to the transistor T2 and the transistor T6 to fix the node N1 and the scanning signal line Gi at the Low potential.

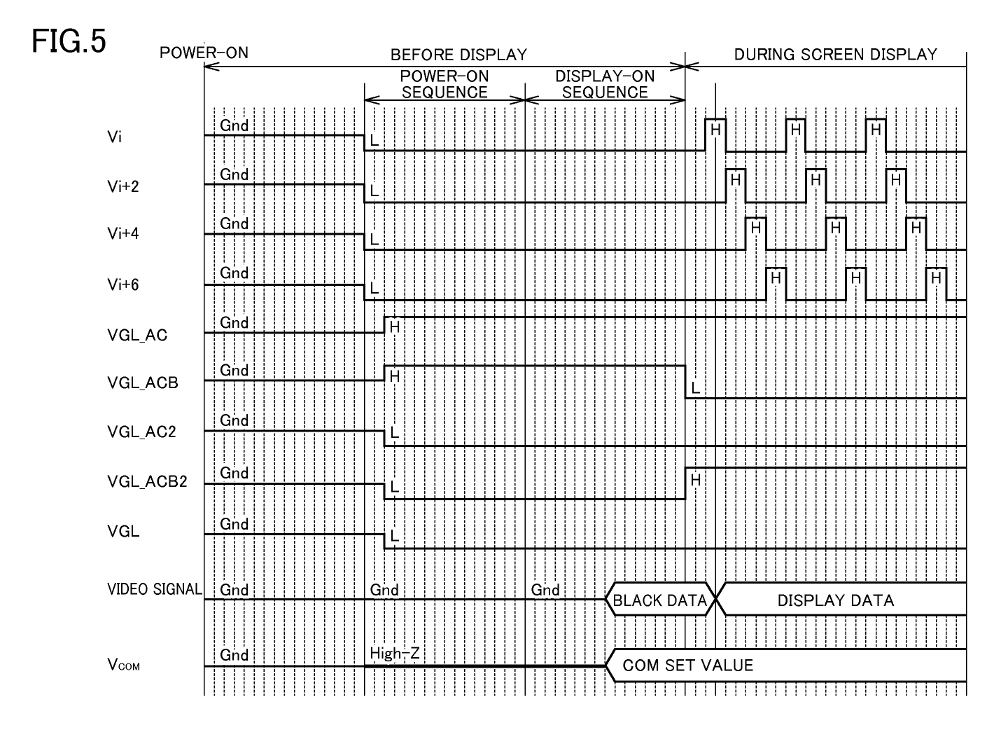

FIG. 5 is a timing diagram showing changes in main signals of a circuit from power-on of the liquid crystal display device 100 to the start of display. As shown in the drawing, all signals are fixed at the GND (ground) potential at the time of power-on. Thereafter, a power-on sequence and a display-on sequence are operated, whereby the potential of each of the signals at the start of display is set. In the embodiment, when the power-on sequence is first started, the driver IC 260 sets the common potential Vcom of the common electrode 243 to high impedance (floating), and fixes clock signals Vi, Vi+2, Vi+4, and Vi+6 at the Low potential. Subsequently, VGL_AC and VGL_ACB are both fixed at the High potential, while VGL_AC2, VGL_ACB2, and VGL are fixed at the Low potential. This is done to render the transistors T6 and T6A conductive to fix the scanning signal line Gi at the Low potential in the circuit diagram of FIG. 4. Moreover, the common potential Vcom is maintained at high impedance until a video signal of black data is applied to the video signal line 245. When the video signal of black data is applied, the common potential Vcom is set to a predetermined potential. Thereafter, usual image display is started.

In the embodiment, after the common potential Vcom of the common electrode 243 is set to high impedance, the scanning signal line Gi is fixed at the Low potential. The common potential Vcom of the common electrode 243 is at high impedance, whereby a potential difference between the common electrode 243 and the scanning signal line Gi is maintained. Therefore, even when the gate potential Vg of the scanning signal line Gi is at the Low potential, the common potential Vcom changes following the change in the gate potential Vg, and an electric field formed by the electrodes does not change. Therefore, it is possible to prevent the alignment of the liquid crystal composition from changing. Accordingly, even when the backlight is turned on, the light leakage in the period from power-on to the start of display can be prevented.

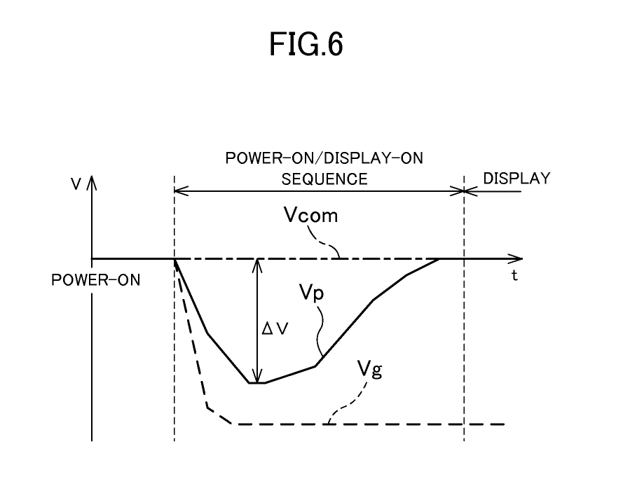

FIG. 6 is a graph schematically showing changes in the gate potential Vg, the pixel potential Vp, and the common potential Vcom during power-on in a related-art example. In the related-art example, it is assumed that the pixel electrode 242 and the common electrode 243 are both connected to the GND (ground) potential or the like. As shown in Formula (1), the potential change ΔVg in the scanning signal line Gi causes the potential change ΔVp in the pixel potential Vp. Here, since the pixel electrode 242 and the common electrode 243 are both at the GND potential, this ΔVp is the potential difference ΔV, without any change, between the pixel potential Vp and the common potential Vcom. The potential difference ΔV is gradually reduced due to leakage. However, an electric field generated by the potential difference ΔV at its peak changes the alignment of a liquid crystal composition, which is the cause of light leakage.

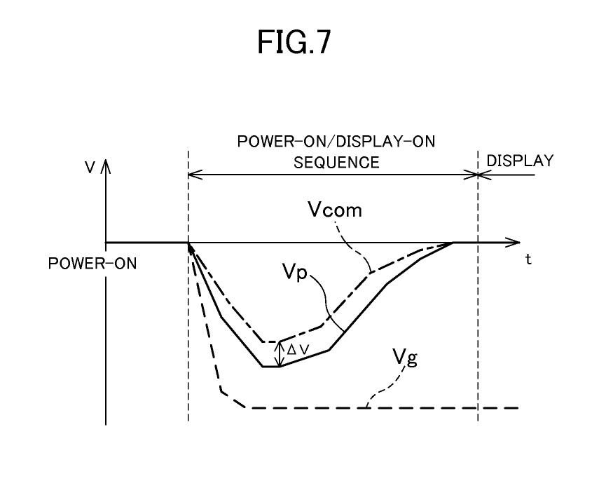

FIG. 7 is a graph schematically showing changes in the gate potential Vg, the pixel potential Vp, and the common potential Vcom during power-on according to the liquid crystal display device 100 of the embodiment. As shown in the graph, since the common potential Vcom is at high impedance, even when the change ΔVp in the pixel potential Vp occurs with the change ΔVg in the scanning signal line Gi, the potential difference ΔV between the pixel potential Vp and the common potential Vcom does not become so large because the common potential Vcom follows the pixel potential Vp, and the pixel potential Vp gradually returns to the same potential due to leakage. For this reason, since an electric field that affects the alignment of the liquid crystal composition is rarely generated, light leakage occurring upon power-on can be suppressed.

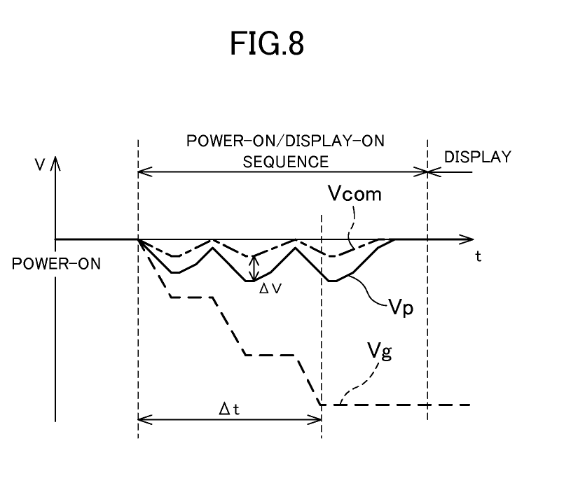

FIG. 8 is a graph schematically showing changes in the gate potential Vg, the pixel potential Vp, and the common potential Vcom during power-on according to a liquid crystal display device of a modified example of the embodiment. In the modified example, the common potential Vcom is at high impedance, and further, the time from the start to the end of a change in the gate potential Vg to the Low potential is a predetermined time Δt or more. With the configuration described above, the potential difference ΔV between the pixel potential Vp and the common potential Vcom is prevented from becoming large by balancing a change in the pixel potential Vp caused by following the gate potential Vg with the return of the pixel potential Vp due to leakage. Even when the configuration described above is employed, an advantageous effect similar to that of the embodiment described above can be obtained. Also, even when the common potential Vcom does not sufficiently follow the pixel potential Vp, the potential difference ΔV can be kept small, and therefore, light leakage can be suppressed. Although the gate potential Vg changes in a stepwise manner in the graph of FIG. 8, the gate potential Vg may be continuously changed for the predetermined time Δt or more. Here, Δt can be set to 1 ms.

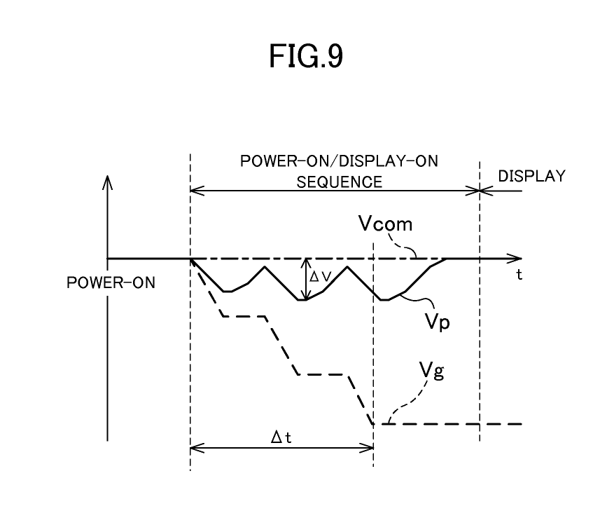

The stepwise change in the potential Vg of the scanning signal line Gi in the modified example is caused with the common potential Vcom at high impedance. As shown in FIG. 9, however, even when the common electrode 243 is fixed at another potential such as the GND potential, the gate potential Vg can be changed to the Low potential by changing the gate potential Vg in a stepwise manner while minimizing the potential difference between the pixel potential Vp and the common potential Vcom.

Although the embodiment has been described on the assumption that the transistor is an n-channel transistor, a p-channel transistor may be used. In this case, the active potential to render the transistor conductive is the Low potential.

While there have been described what are at present considered to be certain embodiments of the invention, it will be understood that various modifications may be made thereto, and it is intended that the appended claim cover all such modifications as fall within the true spirit and scope of the invention.

What is claimed is:

1. A liquid crystal display device comprising:
pixel electrodes to each of which a potential corresponding to a gray-scale value is applied, for a plurality of pixels arranged in a matrix in a display area, via a pixel transistor of each of the pixels;
a common electrode forming, in cooperation with the pixel electrode, an electric field to align a liquid crystal composition;
a plurality of scanning signal lines each connected in common to gates of the pixel transistors of the plurality of pixels constituting each of a plurality of rows forming the matrix; and
a driver circuit setting, after powering on and before displaying an image in the display area, the common electrode into a high impedance state and then setting the scanning signal line to an inactive potential to cut off a source and a drain of the pixel transistor from each other.

2. The liquid crystal display device according to claim 1, wherein
the driver circuit performs control such that in a change in the scanning signal line to the inactive potential, the time from the start to the end of the change is 1 ms or more.

3. The liquid crystal display device according to claim 1, wherein
the driver circuit sets the scanning signal line to the inactive potential in a stepwise manner.

4. A liquid crystal display device comprising:
pixel electrodes to each of which a potential corresponding to a gray-scale value is applied, for a plurality of pixels arranged in a matrix in a display area, via a pixel transistor of each of the pixels;
a common electrode forming, in cooperation with the pixel electrode, an electric field to align a liquid crystal composition;
a plurality of scanning signal lines each connected in common to gates of the pixel transistors of the plurality of pixels constituting each of a plurality of rows forming the matrix; and
a driver circuit setting, after powering on and before displaying an image in the display area, the scanning signal line to an inactive potential to cut off a source and a drain of the pixel transistor from each other, wherein
the driver circuit performs control such that the time from the start to the end of a change in the scanning signal line to the inactive potential is 1 ms or more.
